(19) United States
(12) Patent Application Publication
(10) Pub. No.: US 2022/0367906 A1
(43) Pub. Date: Nov. 17, 2022

(54) ALL SOLID STATE BATTERY

(71) Applicant: Toyota Jidosha Kabushiki Kaisha, Toyota-shi Aichi-ken (JP)

(72) Inventors: Takuya Matsuyama, Susono-shi Shizuoka-ken (JP); Masatsugu Kawakami, Sunto-gun Shizuoka-ken (JP); Tetsuya Waseda, Bunkyo-ku Toyko-to (JP)

(73) Assignee: Toyota Jidosha Kabushiki Kaisha, Toyota-shi Aichi-ken (JP)

(21) Appl. No.: 17/737,155

(22) Filed: May 5, 2022

(30) Foreign Application Priority Data
May 13, 2021 (JP) 2021-081493

(51) Int. Cl. H01M 10/0562; H01M 50/176; H01M 50/124

(52) U.S. Cl. CPC H01M 10/0562; H01M 50/176; H01M 50/1243; H01M 2300/0068

(57) ABSTRACT

An all solid state battery including: a battery cell; a first current collecting member; a second current collecting member; and an outer package. The battery cell contains a sulfide solid electrolyte; the outer package includes a first outer package member arranged on a first surface side of the battery cell, and a second outer package member arranged on a second surface side of the battery cell; a resin layer A is arranged in, at least one position of, a position between the first outer package member and the first current collecting member, and a position between the second outer package member and the second current collecting member; a resin layer B is arranged in a side surface part of the battery cell; and each of the resin layer A and the resin layer B contains an adhesive resin.

### CROSS-REFERENCE TO RELATED APPLICATIONS

This application is based upon and claims the benefit of priority of the prior Japanese Patent Application No. 2021-081493 filed on May 13, 2021, the entire contents of which are incorporated herein by reference.

### TECHNICAL FIELD

The present disclosure relates to an all solid state battery.

### BACKGROUND ART

An all solid state battery is a battery including a solid electrolyte layer between a cathode layer and an anode layer, and one of the aspects thereof is that the simplification of a safety device may be more easily achieved compared to a liquid-based battery including a liquid electrolyte containing a flammable organic solvent. For example, Patent Literature 1 discloses a laminate battery comprising an electrode body, a laminate outer package, and a tab film, wherein a thermoplastic resin layer is arranged in an edge part of the laminate outer package.

### CITATION LIST

### Patent Literature

Patent Literature 1: Japanese Patent Application Laid-Open (JP-A) No. 2019-194949

### SUMMARY OF DISCLOSURE

### Technical Problem

When an all solid state battery is downsized, structural reliability of the all solid state battery tends to degrade. For example, moisture may easily get in a battery cell, and a crack may be easily generated in the battery cell during its production. The present disclosure has been made in view of the above circumstances, and a main object thereof is to provide an all solid state battery in a small size with structural reliability.

### Solution to Problem

In order to achieve the object, the present disclosure provides an all solid state battery comprising: a battery cell; a first current collecting member arranged on a first surface of the battery cell; a second current collecting member arranged on a second surface of the battery cell, which is the surface opposes the first surface; and an outer package that protects the battery cell, the first current collecting member and the second current collecting member; wherein, a size of the all solid state battery is 4 cm² or less; the battery cell contains a sulfide solid electrolyte; the outer package includes a first outer package member arranged on the first surface side of the battery cell, and a second outer package member arranged on the second surface side of the battery cell; a resin layer A is arranged in, at least one position of, a position between the first outer package member and the first current collecting member, and a position between the second outer package member and the second current collecting member; a resin layer B is arranged in a side surface part of the battery cell; and each of the resin layer A and the resin layer B contains an adhesive resin.

According to the present disclosure, a resin layer A is arranged in, at least one position of, a position between the first outer package member and the first current collecting member, and a position between the second outer package member and the second current collecting member, and a resin layer B is arranged in a side surface part of the battery cell; thus the all solid state battery may have structural reliability.

In the disclosure, a resin layer A1 may be arranged as the resin layer A in the position between the first outer package member and the first current collecting member, and the resin layer A1 may be arranged so as to cover whole of the battery cell in a plan view along with a thickness direction.

In the disclosure, a resin layer A2 may be arranged as the resin layer A in the position between the second outer package member and the second current collecting member, and the resin layer A2 may be arranged so as to cover whole of the battery cell in a plan view along with a thickness direction.

In the disclosure, the resin B may be arranged in an entire region from an edge of the first surface side to an edge of the second surface side in the side surface part.

In the disclosure, the resin layer B may be arranged in entire surrounding of outer edge of the battery cell in a plan view along with a thickness direction.

In the disclosure, an area of the battery cell may be 0.1 cm² or less.

### Effects of Disclosure

The present disclosure exhibits an effect of providing an all solid state battery in a small size with structural reliability.

### BRIEF DESCRIPTION OF DRAWINGS

FIG. 1 is a schematic plan view exemplifying the all solid state battery in the present disclosure.

FIG. 2 is a cross-sectional view of A-A in FIG. 1.

FIG. 3 is a cross-sectional view of B-B in FIG. 1.

FIG. 4 is a schematic cross-sectional view exemplifying the resin layer A in the present disclosure.

FIG. 5 is a schematic view-sectional view exemplifying the resin layer A in the present disclosure.

FIG. 6 is a schematic cross-sectional view exemplifying the resin layer B in the present disclosure.

FIG. 7 is a schematic view-sectional view exemplifying the resin layer B in the present disclosure.

FIG. 8 is a schematic cross-sectional view exemplifying the battery cell in the present disclosure.

FIG. 9A is a schematic perspective view explaining the method for producing an evaluation battery in Example 1 in which a laminate film was prepared.

FIG. 9B is a schematic perspective view explaining the method for producing an evaluation battery in Example 1 in which a resin layer A is placed on the laminate film and adhered by a laminate sealer.

FIG. 9C is a schematic perspective view explaining the method for producing an evaluation battery in Example 1 in which a cathode current collecting member (first current correcting member; Al foil) arranged so as to cross the laminate film and the resin layer A, and adhered by a laminate sealer.

FIG. 9D is a schematic perspective view explaining the method for producing an evaluation battery in Example 1 in which a resin layer B in a frame shape was placed on the Al foil and adhered by a laminate sealer.

FIG. 10 is a schematic cross-sectional view exemplifying the evaluation battery produced in Example 1.

FIG. 11 is the result of a charge and discharge test for the evaluation battery produced in Example 1.

FIG. 12 is the result of a charge and discharge test for an evaluation battery produced in Comparative Example 1.

### DESCRIPTION OF EMBODIMENTS

The all solid state battery in the present disclosure is hereinafter explained in details with reference to drawings. Each drawing described as below is a schematic view, and the size and the shape of each portion are appropriately exaggerated in order to be understood easily.

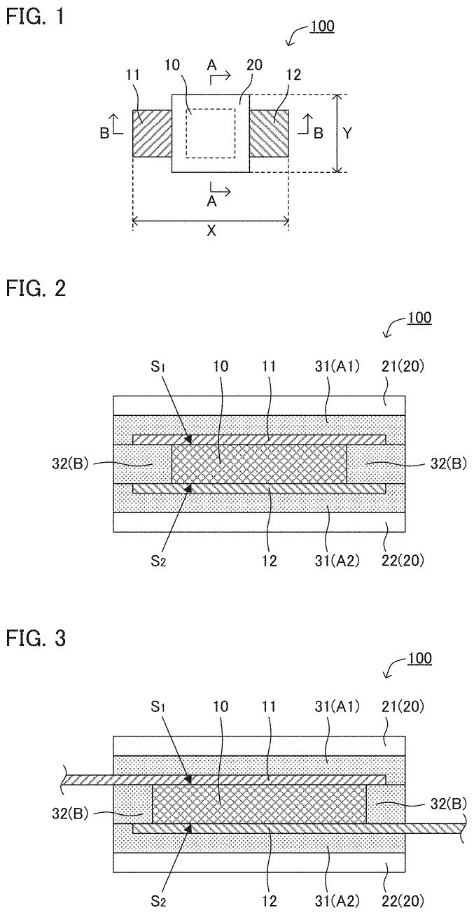

FIG. 1 is a schematic plan view exemplifying the all solid state battery in the present disclosure. All solid state battery 100 shown in FIG. 1 comprises battery cell 10 including a cathode layer, a solid electrolyte layer and an anode layer, outer package 20 that protects the battery cell 10, and first current collecting member 11 and second current collecting member 12 for taking out electricity generated in the battery cell 10. The battery cell 10 contains a sulfide solid electrolyte. Also, the size of the all solid state battery 100 is represented by the product of length X of the all solid state battery 100 in a first direction, which is from the end part (end part on the left side of the paper in FIG. 1) of the first current collecting member 11 to the end part (end part on the right side of the paper in FIG. 1) of the second current collecting member 12, and length Y of the all solid state battery 100 in a second direction that is orthogonal to the first direction, and the size is usually 4 cm² or less.

FIG. 2 is a cross-sectional view of A-A in FIG. 1, and FIG. 3 is a cross-sectional view of B-B in FIG. 1. As shown in FIG. 2 and FIG. 3, all solid state battery 100 includes: battery cell 10; first current collecting member 11 arranged on first surface S₁ of the battery cell 10; second current collecting member 12 arranged on second surface S₂ of the battery cell 10, which is the surface opposes the first surface S₁; and outer package 20 that protects the battery cell 10, the first current collecting member 11 and the second current collecting member 12. The outer package 20 includes first outer package member 21 arranged on the first surface S₁ side of the battery cell 10, and second outer package member 22 arranged on the second surface S₂ side of the battery cell 10. Further, resin layer A1 (resin layer 31) is arranged in a position between the first outer package member 21 and the first current collecting member 11, and resin layer A2 (resin layer 31) is arranged in a position between the second outer package member 22 and the second current collecting member 12. Further, resin layer B (resin layer 32) is arranged in a side surface part of the battery cell 10. Each of the resin layer A1, the resin layer A2 and the resin layer B contains an adhesive resin.

According to the present disclosure, a resin layer A is arranged in, at least one position of, a position between the first outer package member and the first current collecting member, and a position between the second outer package member and the second current collecting member, and a resin layer B is arranged in a side surface part of the battery cell; thus the all solid state battery may have structural reliability.

As described above, when an all solid state battery is downsized, structural reliability of the all solid state battery tends to degrade. For example, moisture may easily get in a battery cell, and a crack may be easily generated in the battery cell during its production. In the present disclosure, the resin layer A and the resin layer B respectively containing an adhesive resin is arranged in the specified position. Moisture is prevented from getting in the battery cell by protecting the surrounding of the battery cell with the resin layer A and the resin layer B. Also, a crack of the battery cell during production is prevented from generating when the resin layer A and the resin layer B work as cushioning.

Also, when the size of an all solid state battery is large, for example, it is possible to sufficiently increase the area of a seal part in which outer packages are welded, and thus improving the structural reliability of the outer package is comparatively easy. On the other hand, when an all solid state battery is miniaturized (such as to the size of 2 cm length by 2 cm width or less), the structural reliability tends to degrade since limitations due to the size increases. Further, the performance of a sulfide solid electrolyte included in the battery cell remarkably degrades when reacted with moisture, and thus it is necessary to strictly control moisture when a battery cell containing a sulfide solid electrolyte is used. In this manner, by using the resin layer A and the resin layer B, the present disclosure achieves the object peculiar to an all solid state battery that is miniaturized and using a sulfide solid electrolyte.

1. Constitution of all Solid State Battery

A size of the all solid state battery in the present disclosure is usually 4 cm² or less. The size of the all solid state battery is, as shown in FIG. 1, represented by the product of length X of the all solid state battery 100 in a first direction, which is from the end part of the first current collecting member 11 to the end part of the second current collecting member 12, and length Y of the all solid state battery 100 in a second direction that is orthogonal to the first direction. For example, the first direction corresponds to longer direction of the first current collecting member 11 and the second current collecting member 12, and the second direction corresponds to shorter direction of the first current collecting member 11 and the second current collecting member 12.

The size of the all solid state battery may be 2 cm² or less, and may be 1 cm² or less. Meanwhile, the size of the all solid state battery is, for example, 0.04 cm² or more and may be 0.1 cm² or more. Each of X and Y is, for example, 2 cm or less and may be 1 cm or less. Meanwhile, each of X and Y is, for example, 0.2 cm or more. Also, the area of the battery cell (the area in a plan view along with the thickness direction) is not particularly limited, and for example, it is 0.5 cm² or less and may be 0.3 cm² or less. Meanwhile, the area of the battery cell is, for example, 0.01 cm² or more.

In the present disclosure, the resin layer A is usually arranged in, at least one position of, a position between the first outer package member and the first current collecting member, and a position between the second outer package member and the second current collecting member. By arranging the resin layer A, the adhesiveness of the outer package member and the current collecting member improves and the structural reliability of the all solid state battery improves. In particular, when the outer package member includes a heat weldable resin layer as an inner layer (a layer closest to the battery cell) and when the current collecting member is a metal, by arranging the resin layer A between the two, the adhesiveness of the outer package member and the current collecting member remarkably improves. The adhesiveness of the outer package member and the current collecting member remarkably improves when a resin included in the resin layer A adheres to a resin included in the heat weldable resin layer on one surface side, and when the resin included in the resin layer A adheres rigidly to the current collecting member made of metal on the other surface side.

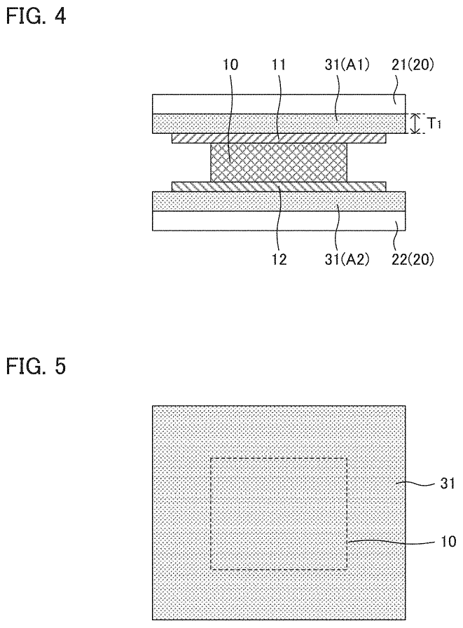

For example, in FIG. 4, resin layer A1 is arranged in a position between the first outer package member 21 and the first current collecting member 11, and resin layer A2 is arranged in a position between the second outer package member 22 and the second current collecting member 12. Incidentally, although not particularly illustrated, either one of the resin layer A1 or the resin layer A2 may not be arranged. Also, as shown in FIG. 4, the thickness of the resin layer A (resin layer 31) is regarded as T₁. T₁ is not particularly limited; for example, it is 50 μm or more, may be 70 μm or more, and may be 90 μm or more. If T₁ is too small, there is a possibility that structural reliability may not be obtained. Meanwhile, T₁ is, for example, 300 μm or less and may be 200 μm or less. If T₁ is too large, the proportion of the battery cell would be relatively small, and there is a possibility that volume energy density may not be obtained.

Also, in a plan view along with the thickness direction, the resin layer A is usually arranged so as to at least partially overlap with the battery cell. In some embodiments, as shown in FIG. 5, the resin layer A (resin layer 31) is arranged so as to cover whole of the battery cell 10. The reason therefor is to improve structural reliability. In some embodiments of the present disclosure, in a plan view along with the thickness direction, the both of the resin layer A1 and the resin layer A2 are arranged so as to cover whole of the battery cell 10.

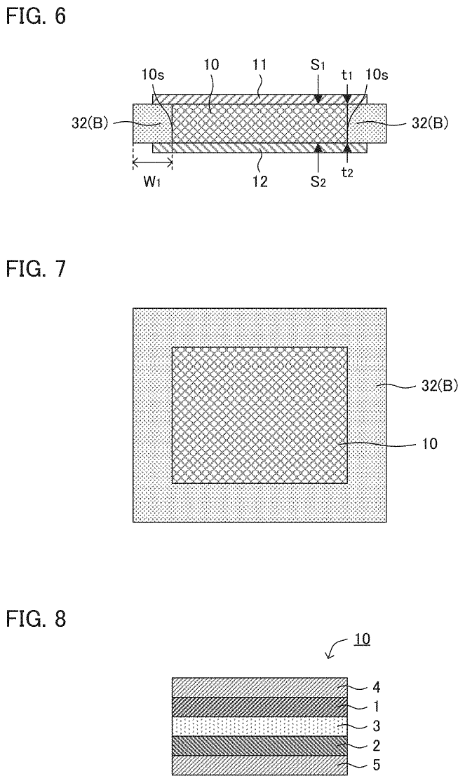

In the present disclosure, a resin layer B is usually arranged in a side surface part of the battery cell. For example, in FIG. 6, resin layer B (resin layer 32) is arranged in side surface part 10s of the battery cell 10. The resin layer B is arranged in at least a part of region in the side part 10s of the battery cell 10. In some embodiments, as shown in FIG. 6, the resin layer B (resin layer 32) is arranged in the entire region from edge t₁ of the first surface S₁ side to edge t₂ of the second surface S₂ side in the side surface part 10s. Also, as shown in FIG. 6, the width of the resin layer B (resin layer 32) is regarded as Wi. Wi is not particularly limited, and for example, it is 100 μm or more, and may be 1000 μm or more. If Wi is too small, there is a possibility that structural reliability may not be obtained. Meanwhile, Wi is, for example, 3000 μm or less and may be 2000 μm or less. If Wi is too large, the proportion of the battery cell would be relatively small, and there is a possibility that volume energy density may not be obtained.

Also, the resin layer B is usually arranged in at least a part of outer edge of the battery cell in a plan view along with a thickness direction. In some embodiments, as shown in FIG. 7, the resin layer B (resin layer 32) is arranged in the entire surrounding of the battery cell 10. The reason therefor is to improve structural reliability. In some embodiments, the resin layer B completely cover the side surface part of the battery cell. In other words, in some embodiments, the resin layer B is arranged so as not to expose any regions in the side surface part of the battery cell.

Incidentally, as shown in FIG. 2 and FIG. 3, an interface may be present between the resin layer A (resin layer 31) and the resin layer B (resin layer 32), and the interface may not be present but the both may be integrated.

2. Members of all Solid State Battery

The all solid state battery in the present disclosure comprises a resin layer, a battery cell, a first current collecting member, a second current collecting member and an outer package.

(1) Resin Layer

The all solid state battery in the present disclosure comprises the above described resin layer A and resin layer B as the resin layer containing an adhesive resin. The adhesive resin is not particularly limited if it is a resin capable of exhibiting adhesiveness to the current collecting member (typically current collecting member made of metal), and examples thereof may include a modified polyolefin such as a modified polypropylene to which adhesiveness is given by introducing a functional group (such as ADMER™ from Mitsui Chemicals, Inc.). The adhesive resin to be used in the resin layer A and the resin layer B may or may not be the same.

(2) Battery Cell, First Current Collecting Member, Second Current Collecting Member

The battery cell in the present disclosure usually includes a cathode layer, a solid electrolyte layer and an anode layer. In the battery cell, a cathode current collector may be arranged on the opposite side surface to the solid electrolyte of the cathode layer. Similarly, an anode current collector may be arranged on the opposite side surface to the solid electrolyte of the anode layer. Battery cell 10 shown in FIG. 8 includes cathode layer 1, anode layer 2, solid electrolyte layer 3 arranged between the cathode layer 1 and the anode layer 2, cathode current collector 4 for collecting currents of the cathode layer 1, and anode current collector 5 for collecting current of the anode layer 2. The battery cell may include one of a power generating unit including a cathode layer, a solid electrolyte layer and an anode layer, or may include two or more of the power generating unit.

In some embodiments, the surface of the battery cell is entirely covered with the resin layer A and the resin layer B. In some embodiments, (i) to (iii) are satisfied:

(i) each of the resin layer A1 and the resin layer A2 are arranged so as to cover whole of the battery cell in a plan view along with the thickness direction;
(ii) the resin B is arranged in an entire region from an edge of the first surface side to an edge of the second surface side in the side surface part; and
(iii) the resin layer B is arranged in entire surrounding of outer edge of the battery cell in a plan view along with a thickness direction.

The battery cell includes a cathode layer, a solid electrolyte layer and an anode layer. Further, at least one of the cathode layer, the solid electrolyte layer and the anode layer contains a sulfide solid electrolyte. The thickness of the battery cell is not particularly limited, and for example, it is 20 μm or more and 200 μm or less.

The cathode layer contains at least a cathode active material, and may further contain at least one of a sulfide solid electrolyte, a conductive material and a binder. Examples of the cathode active material may include an oxide active material. Examples of the oxide active material may include a rock salt bed type active material such as LiNi_{1/3}Co_{1/3}Mn_{1/3}O₂ and LiNiO₂.

In some embodiments, the sulfide solid electrolyte contains, for example, a Li element, an X element (X is at least one kind of P, As, Sb, Si, Ge, Sn, B, Al, Ga, and In), and a S element. Also, the sulfide solid electrolyte may contain at least one of a Cl element, a Br element and an I element as a halogen element. Also, the sulfide solid electrolyte may contain an O element. The sulfide solid electrolyte may be glass-based sulfide solid electrolyte, may be glass ceramic-based sulfide solid electrolyte, and may be a crystal-based sulfide solid electrolyte. Also, when the sulfide solid electrolyte includes a crystal phase, examples of the crystal phase may include a Thio-LISICON type crystal phase, a LGPS type crystal phase and an argyrodite type crystal phase.

Examples of the conductive material may include acetylene black, Ketjen black, VGCF, and graphite. Examples of the binder may include a fluoride-based binder.

The anode layer contains at least an anode active material, and may further contain at least one of a sulfide solid electrolyte, a conductive material, and a binder. Examples may include a carbon-based active material such as graphite, a metal-based active material such as Si, and an oxide-based active material such as lithium titanate. The sulfide solid electrolyte, conductive material and the binder are as described above.

The solid electrolyte layer contains at least a solid electrolyte, and further may contain a binder. In some embodiments, the solid electrolyte layer contains a sulfide solid electrolyte as the solid electrolyte. The sulfide solid electrolyte and the binder are as described above.

Examples of the material for the cathode current collector may include Al, SUS and Ni. Examples of the material for the anode current collector may include Cu, SUS and Ni. Examples of the shape of the current collectors may include a foil shape, a mesh shape, and a porous shape. The thickness of the current collectors (cathode current collector and anode current collector) is not particularly limited, and for example, it is 10 μm or more and 50 μm or less. Also, the material, the shape, and the thickness of the current collecting members (first current collecting member and second current collecting member) are the same as those of the current collectors. In the current collecting members, a part exposed from the outer package usually works as a terminal. In some embodiments, the polarity of the first current collecting member and the polarity of second current collector are different.

(3) Outer Package

The outer package is a member that protects the battery cell, the first current collecting member and the second current collecting member. As shown in FIG. 2, outer package 20 includes first outer package member 21 arranged on the first surface S₁ side of the battery cell 10, and second outer package member 22 arranged on the second surface S₂ side of the battery cell 10.

In some embodiments, the outer package is in a film shape (sheet shape). Also, the outer package includes, for example, a heat resisting resin layer that is an outer layer, a metal foil layer that is an intermediate layer, and a heat weldable resin layer that is an inner layer. A seal part can be formed by heat welding the heat weldable resin layers.

In the outer package, the heat resisting resin layer works as a substrate layer, the metal foil layer works as a barrier layer, and the heat weldable resin layer works as a sealant layer. Examples of the resin used for the heat resisting resin layer may include polyamide such as nylon, polyethylene terephthalate, methyl polymethacrylate, polypropylene, polycarbonate and polyalkylene terephthalate. Examples of metal materials used for the metal foil layer may include aluminum, stainless, titanium, nickel, and copper. Examples of the resin used in the heat weldable resin layer may include an acid-modified polyolefin, polyethylene, and polypropylene. The thickness of the outer package is not particularly limited, and for example, it is 100 μm or more and 300 μm or less.

(4) All Solid State Battery

The all solid state battery in the present disclosure is typically an all solid lithium secondary battery. Also, the all solid state battery in the present disclosure is in a small size, and can be used in various applications. Examples of the applications of the all solid state battery may include a power source for printing substrate.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

<Production of Cathode Layer>

A PVDF-based binder (from KUREHA CORPORATION), a cathode active material (LiNi_{1/3}Co_{1/3}Mn_{1/3}O₂) coated with LiNbO₃, a sulfide solid electrolyte (Li₂S—P₂S₅-based glass ceramic), a conductive material (VGCF from SHOWA DENKO K.K) and butyl butyrate were added to a container made of polypropylene, and agitated for 30 seconds by an ultrasonic dispersion device (UH-50 from SMT Corporation). Next, the container was shaken for 3 minutes by a shaker (TTM-1 from SIBATA SCIENTIFIC TECHNOLOGY LTD.) and further agitated by the ultrasonic dispersion device for 30 seconds to obtain a slurry. The obtained slurry was pasted on an Al foil by a blade method using an applicator. The coated layer was dried naturally and further dried for 30 minutes on a hot plate at 100° C. to form a cathode layer on the Al foil.

### <Production of Anode Layer>

A PVDF-based binder (from KUREHA CORPORATION), an anode active material (lithium titanate; LTO), a sulfide solid electrolyte (Li₂S—P₂S₅-based glass ceramic), and butyl butyrate were added to a container made of polypropylene, and agitated for 30 seconds by an ultrasonic dispersion device (UH-50 from SMT Corporation) to obtain a slurry. The obtained slurry was pasted on a Cu foil by a blade method using an applicator. The coated layer was dried naturally and further dried for 30 minutes on a hot plate at 100° C. to form an anode layer on the Cu foil.

<Production of Solid Electrolyte Layer>

A sulfide solid electrolyte (Li₂S—P₂S₅-based glass ceramic) and butyl butyrate were added to a container made of polypropylene, and agitated for 30 seconds by an ultrasonic dispersion device (UH-50 from SMT Corporation). Next, the container made of PP was shaken for 30 minutes by a shaker (TTM-1 from SIBATA SCIENTIFIC TECHNOLOGY LTD.) and further agitated by the ultrasonic dispersion device for 30 seconds to obtain a slurry. The obtained slurry was pasted on an Al foil by a blade method using an applicator. The coated layer was dried naturally and further dried for 30 minutes on a hot plate at 100° C. to form a solid electrolyte layer on the Al foil.

<Production of Battery Cell>

The cathode layer and the solid electrolyte layer were placed one upon another so that the cathode layer contacted the solid electrolyte layer, pressed, and then the Al foil of the solid electrolyte layer was peeled off. After that, the solid electrolyte layer exposed was layered onto the anode layer so as to contact with each other, and pressed. Next, the product was punched out by a hand pressing machine to produce a battery cell in a size of 2 mm by 5 mm.

<Production of Evaluation Battery>

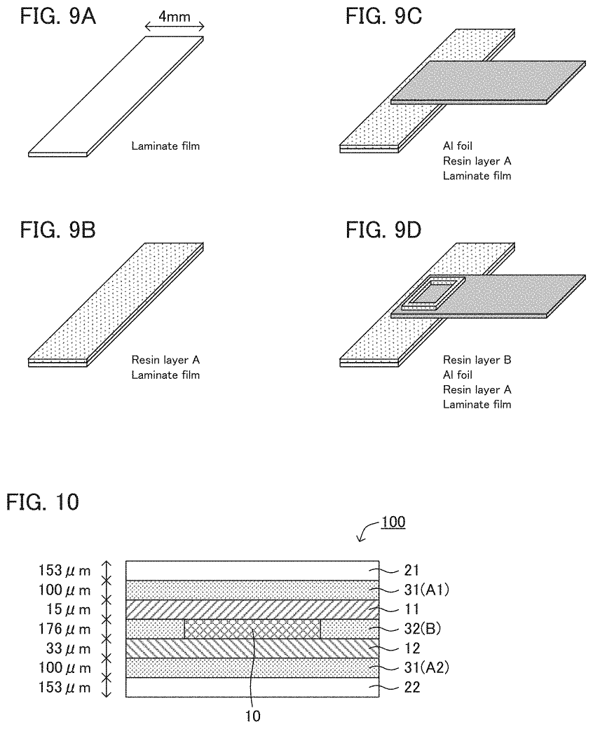

A cathode side laminate layered body was produced by the processes shown in FIGS. 9A to 9D. As shown in FIG. 9A, a laminate film cut in a size of 4 mm width was prepared. Next, as shown in FIG. 9B, resin layer A was placed on the laminate film and adhered by a laminate sealer. Next, as shown in FIG. 9C, a cathode current collecting member (first current correcting member; Al foil) cut into a size of 4 mm width was arranged so as to cross the laminate film and the resin layer A, and adhered by a laminate sealer. Next, as shown in FIG. 9D, resin layer B in a frame shape was placed on the Al foil and adhered by a laminate sealer. Thereby, the cathode side laminate layered body including layers in the order of, the laminate film, the resin layer A, the Al foil and the resin layer B, was obtained. An adhesive polyolefin from Mitsui Chemicals, Inc. (ADMER™) was used in the resin layer A and the resin layer B.

Meanwhile, an anode side laminate layered body was produced in the same manner as for the cathode side laminate layered body except that an anode current collecting member (second current collecting member; Ni foil) was used instead of the cathode current collecting member (first current collecting member; Al foil). The battery cell was arranged between the cathode side laminate layered body and the anode side laminate layered body, and the battery cell was sealed by a laminate sealer. Thereby, as shown in FIG. 10, an evaluation battery having the layer structure of: the first outer package member 21, the resin layer A1, the first current collecting member 11, the battery cell 10, the resin layer B, the second current collecting member 12, the resin layer A2, the second outer package member 22, was obtained. The thickness of each member was as shown in FIG. 10. Also, the battery size was 0.7 cm² (X=10 mm, Y=7 mm), and the area of the battery cell was 0.1 cm².

### Comparative Example 1

An evaluation battery was produced in the same manner as in Example 1 except that the resin layer B was not used.

### Comparative Example 2

An evaluation battery was produced in the same manner as in Example 1 except that the resin layer A1, the resin layer A2 and the resin layer B were not used.

[Evaluation]

<Charge and Discharge Test>

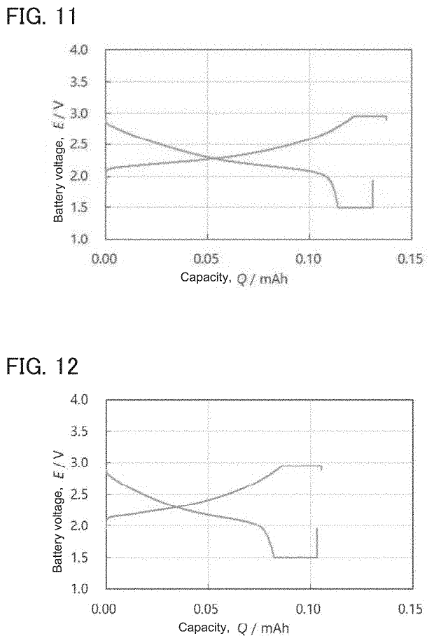

CC-CV charge and discharge were conducted to the evaluation batteries obtained in Example 1 and Comparative Examples 1 and 2 in a constant temperature bath of which water temperature was set to 25° C., in the voltage range of 3.0 V to 1.5 V. The current density was ⅓ C (0.055 mA). The result of Example 1 is shown in FIG. 11, and the result of Comparative Example 1 is shown in FIG. 12.

As shown in FIG. 11 and FIG. 12, it was confirmed that the evaluation batteries obtained in Example 1 and Comparative Example 1 operated as a battery, but the discharge capacity of Example 1 was more than that of Comparative Example 1. This is presumably because the structural reliability of the evaluation battery in Example 1 was higher than that of the evaluation battery in Comparative Example 1. On the other hand, the evaluation battery in Comparative Example 2 did not operate as a battery since moisture got in the battery cell due to lack of sealing of the outer package.

### REFERENCE SIGNS LIST

1 cathode layer
2 anode layer
3 solid electrolyte layer
4 cathode current collector
5 anode current collector
10 battery cell
11 first current collecting member
12 second current collecting member
20 outer package
21 first outer package member
22 second outer package member
31 resin layer A
32 resin layer B
100 all solid state battery

What is claimed is:

1. An all solid state battery comprising:
a battery cell;
a first current collecting member arranged on a first surface of the battery cell;
a second current collecting member arranged on a second surface of the battery cell, which is the surface opposes the first surface; and
an outer package that protects the battery cell, the first current collecting member and the second current collecting member; wherein,
a size of the all solid state battery is 4 cm² or less;
the battery cell contains a sulfide solid electrolyte;
the outer package includes a first outer package member arranged on the first surface side of the battery cell, and a second outer package member arranged on the second surface side of the battery cell;
a resin layer A is arranged in, at least one position of, a position between the first outer package member and the first current collecting member, and a position between the second outer package member and the second current collecting member;
a resin layer B is arranged in a side surface part of the battery cell; and
each of the resin layer A and the resin layer B contains an adhesive resin.

2. The all solid state battery according to claim 1, wherein a resin layer A1 is arranged as the resin layer A in the position between the first outer package member and the first current collecting member, and the resin layer A1 is arranged so as to cover whole of the battery cell in a plan view along with a thickness direction.

3. The all solid state battery according to claim 2, wherein a resin layer A2 is arranged as the resin layer A in the position between the second outer package member and the second current collecting member, and the resin layer A2 is arranged so as to cover whole of the battery cell in a plan view along with a thickness direction.

4. The all solid state battery according to claim 1, wherein the resin B is arranged in an entire region from an edge of the first surface side to an edge of the second surface side in the side surface part.

5. The all solid state battery according to claim 1, wherein the resin layer B is arranged in entire surrounding of outer edge of the battery cell in a plan view along with a thickness direction.

6. The all solid state battery according to claim 1, wherein an area of the battery cell is 0.1 cm² or less.
